(19) United States
(12) Patent Application Publication
(10) Pub. No.: US 2020/0148026 A1
(43) Pub. Date: May 14, 2020

(54) AUTOMATIC COOLING/HEATING CONTROL METHOD OF AIR CONDITIONER FOR VEHICLE

(71) Applicant: CEDIC CO., LTD., Seoul (KR)

(72) Inventors: Jang-Hyung CHO, Seoul (KR); Wan-Ho JEON, Seoul (KR); Byeong-Kang Yoo, Seoul (KR); Joo-Ho SIM, Seoul (KR)

(73) Assignee: CEDIC CO., LTD., Seoul (KR)

(21) Appl. No.: 16/318,678

(22) PCT Filed: Nov. 22, 2018
(86) PCT No.: PCT/KR2018/014412

§ 371 Date: Jan. 17, 2019

(30) Foreign Application Priority Data
Nov. 14, 2018 (KR) 10-2018-0139855

(51) Int. Cl. B60H 1/00

(52) U.S. Cl. CPC B60H 1/0073; B60H 1/00807

(57) ABSTRACT

The present invention relates generally to an automatic cooling/heating control method of an air conditioner for a vehicle. The present invention is intended to propose the control method, wherein instead of controlling indoor temperature via manual manipulation, operation modes set in figurative languages, not temperature, are used so as to automatically control indoor cooling/heating, whereby an atmosphere more pleasant than an atmosphere provided by a conventional method is efficiently provided and manipulation frequency of a console is reduced. To achieve the above objects, the control method includes: selecting an air operation mode desired by a user; starting an initial operation by the air conditioner after determining whether to cool, heat, or fan; setting the indoor temperature according to the outdoor temperature; resetting the set indoor temperature by using a correction value according to present indoor temperature; and operating by setting a reset indoor temperature to be a final set temperature.

### TECHNICAL FIELD

The present invention relates generally to an automatic cooling/heating control method of an air conditioner for a vehicle. More particularly, the present invention relates to an automatic cooling/heating control method, wherein unlike a conventional method of setting temperature during control of an air conditioner for a vehicle, a command such as “warm” or “cold” that indicates a temperature state of air a user feels in a vehicle is received as to control the air conditioner so that a pleasant temperature state that the user desires in the vehicle is realized.

### BACKGROUND ART

Generally, as for a conventional air conditioning control device for a vehicle, a driver or a passenger uses a control manipulation part of a center console in a vehicle so as to manipulate an air conditioner.

The control manipulation part of the console may be manipulated in a manual mode in which each of an air blowing fan, the air conditioner, and a damper is manipulated manually, and in an automatic mode in which each of air conditioning parts is automatically operated by setting any desired temperature value so as to obtain a desired temperature. Accordingly, a user controls temperature via manual manipulation according to an indoor temperature.

However, since every user has different indoor temperature preference, the method of setting a temperature value according to the indoor temperature increases frequency of center console manipulation for increasing or decreasing temperature, whereby a driver is distracted.

### DOCUMENT OF RELATED ART

(Patent Document 1)

Korean Patent Application Publication No. 10-2001-0045980

### DISCLOSURE

### Technical Problem

The present invention is intended to propose an automatic cooling/heating control method, wherein instead of controlling indoor temperature via manual manipulation, operation modes set in figurative languages, not temperature, are used so as to automatically control indoor cooling/heating, whereby an atmosphere more pleasant than an atmosphere provided by a conventional method is efficiently provided and manipulation frequency of a console is reduced.

### Technical Solution

In order to accomplish the above objects, the present invention provides an automatic cooling/heating control method of an air conditioner for a vehicle, the control method including:

selecting an air operation mode desired by a user in the air conditioner;

starting an initial operation by the air conditioner after determining whether to cool, heat, or fan by measuring indoor temperature and outdoor temperature via the selected air operation mode;

setting the indoor temperature according to the outdoor temperature when the initial operation mode stops;

resetting the set indoor temperature by using a correction value according to present indoor temperature; and

operating by setting a reset indoor temperature to be a final set temperature by adding compensation temperature determined by each operation mode to the reset indoor temperature.

In addition, the automatic cooling/heating control method of an air conditioner for a vehicle may further include:

determining a set value automatically and storing the set value in a micro controller unit (MCU) by manipulating the set temperature via upward and downward manipulations of a temperature manipulation button of the air conditioner and by reflecting a manipulated set temperature in temperature reset in each operation mode when an operation condition set as the final set temperature is not suitable for pleasantness of a user.

Here, the air operation mode may include a pleasant mode, a cool mode, a temperate mode, a baby mode, and a speedy mode, wherein the pleasant mode, the cool mode, the temperate mode, the baby mode, and the speedy mode may be set to be 24° C., 20° C., 27° C., 25° C., and 18° C., respectively.

The initial operation may be maintained for two minutes.

The correction value according to the indoor temperature may range between +2° C. and −2° C. when the indoor temperature is between 15° C. and 28° C., and

the compensation temperature may be set to be 0° C. in a pleasant mode, −2° C. in a cool mode, +2° C. in a temperate mode, +3.5° C. in a baby mode, and −5° C. in a speedy mode,

wherein the temperature reset by adding the compensation temperature may be set within a limitation value of the reset temperature according to the operation mode.

The limitation value of the reset temperature may range to be 20° C. to 26° C. in the pleasant mode, 18° C. to 25° C. in the cool mode, 22° C. to 30° C. in the temperate mode, 20° C. to 28° C. in the baby mode, and 16° C. to 24° C. in the speedy mode.

The final set temperature may be calculated every ten minutes.

### Advantageous Effects

According to the present invention, a personal feeling that is difficult to be quantified is set in air conditioner modes expressed in figurative languages, whereby a pleasant atmosphere is efficiently and automatically provided and manipulation frequency of a console can be reduced.

### DESCRIPTION OF DRAWINGS

FIG. 1 is a graph roughly showing a method of setting an initial operation condition;

FIG. 2 is a graph showing a temperature setting range according to outdoor temperature; and

FIG. 3 is a graph showing a correction value according to indoor temperature.

### MODE FOR INVENTION

Hereinbelow, the present invention will be described in detail with reference to the accompanying drawings.

According to the present invention, first, an air operation mode desired by a user is selected by using a console in a vehicle. The user selects a pleasant mode, a cool mode, a temperate mode, a baby mode, a speedy cooling mode, or a speedy heating mode. In this case, the pleasant mode, the cool mode, the temperate mode, the baby mode, the speedy cooling mode, and the speedy heating mode are set to be 24° C., 20° C., 27° C., 25° C., 18° C., and 32° C., respectively, by each mode.

Here, a reason for which the air operation mode is divided into the pleasant mode, the cool mode, the temperate mode, the baby mode, the speedy cooling mode, and the speedy heating mode is to place a minimum of temperature division according to indoor temperature required by a user. Temperatures by each mode, that is, a reason for which the pleasant mode is set to be 24° C. is that 24° C. is temperature that normally causes the most pleasant feeling, a reason for which the cool mode is set to be 20° C. is to meet more coolness that a user desires, a reason for which the temperate mode is set to be 27° C. is to meet more warmth that a user desires, a reason for which the baby mode is set to be 25° C. is to make a baby pleasant, a reason for which the speedy cooling mode is set to be 18° C. is to operate by setting cooling operation load to the maximum, and a reason for which the speedy heating mode is set to be 32° C. is to set heating operation load to the maximum.

When the air operation mode is selected, an air conditioner measures indoor temperature and outdoor temperature via the selected air operation mode, determines whether to heat, fan, or cool, and starts an initial operation.

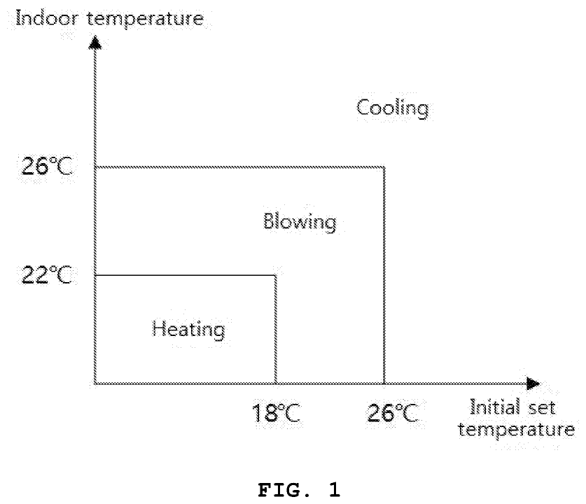

As shown in FIG. 1, the initial operation starts by determining whether to heat, fan, or cool according to correlation between the indoor temperature and an initial set temperature by each operation condition. For example, when the outdoor temperature is 18° C. or less and the indoor temperature is 22° C. or less, a heating operation is performed, when the outdoor temperature is between 18 and 26° C. and the indoor temperature is between 22 and 26° C., a blowing operation is performed, and when the outdoor temperature and the indoor temperature are 26° C. or more, a cooling operation is performed, and in this case, each of the operations is performed by changing to the set temperature of the operation mode set by a user.

The initial operation is maintained for two minutes and here, a reason the initial operation is maintained for two minutes is to measure an initial indoor temperature and complete the initial operation of various kinds of air conditioning parts. (The two minutes is time required to reach a normal operation condition by operating parts)

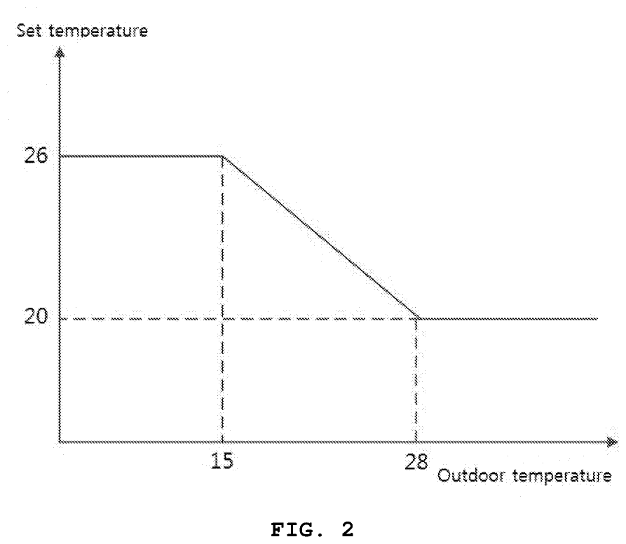

When the initial operation mode of two minutes stops, as shown in FIG. 2, the set temperature is set according to an operation condition according to the outdoor temperature. For example, when the outdoor temperature is 15° C. or less, the set temperature is set to be 26° C. or more, when the outdoor temperature is 28° C. or more, the set temperature is set to be 20° C. or less, and when the outdoor temperature is between 15° C. and 28° C., the set temperature is set to be between 20° C. and 26° C.

Here, a reason for which the set temperature is set is to predict indoor temperature load according to an outdoor temperature condition and compensate for the indoor temperature load.

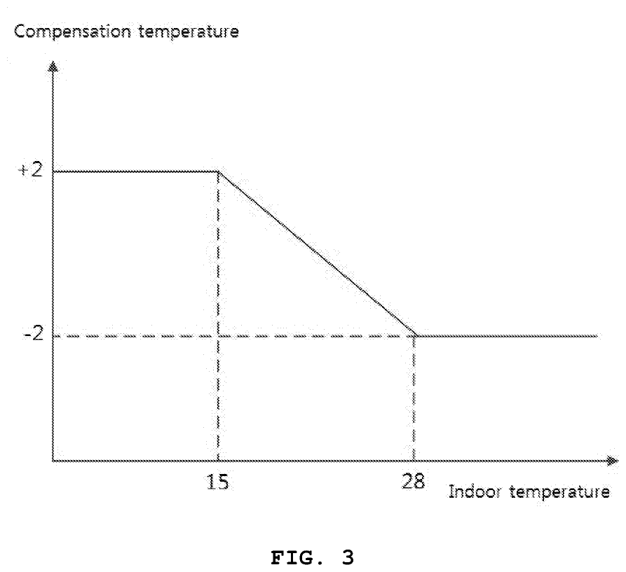

As shown in FIG. 3, the set temperature has a correction value according to the indoor temperature added thereto so as to reset the set temperature. For example, when the indoor temperature is 15° C. or less, the indoor temperature is reset to add +2° C. thereto, when the indoor temperature is 28° C. or more, the indoor temperature is reset to add −2° C. thereto, and when the indoor temperature is between 15° C. and 28° C., the indoor temperature is reset to add temperature between +2° C. and −2° C. thereto.

Here, a reason for which the correction value is limited is to prevent indoor air temperature from overshooting due to excessive temperature setting.

A reset temperature is set to be a final set temperature by adding compensation temperature according to each operation mode. In this case, the compensation temperature includes 0° C. in the pleasant mode, −2° C. in the cool mode, +2° C. in the temperate mode, +3.5° C. in the baby mode, −5° C. in a speedy cooling mode, and +5° C. in a speedy heating mode.

Here, a reason for which the compensation temperature is set is to compensate for the set temperature according to the operation condition since the reset temperature is temperature set in line with pleasant temperature.

The final set temperature is calculated every ten minutes, and in this case, the calculated value is rounded off to the nearest hundredths.

The final set temperature according to each operation mode cannot be reset beyond the following maximum and minimum values. A limitation value by each operation mode is limited to be 20 to 26° C. in the pleasant mode, 18 to 25° C. in the cool mode, 22 to 30° C. in the temperate mode, 20 to 28° C. in the baby mode, 16 to 24° C. in the speedy cooling mode, and 26 to 32° C. in the speedy heating mode.

Here, a reason for which the limitation value is limited is not to lose a characteristic of the operation condition due to excessive correction of the set temperature.

When a set operation condition is not suitable for pleasantness of a user during a set operation, the set temperature may be manipulated upward or downward. A manipulated set temperature is stored automatically and reflected in temperature reset in each operation mode so as to determine a set value, and the set value is stored in a micro controller unit (MCU) and during a later operation, a set value of the air conditioner is set based on the automatically stored manipulated temperature.

When the indoor temperature reaches temperature set during operation in an additionally set operation mode, a driver is asked by the console whether he or she is satisfied with a present temperature state, and the temperature is changed to temperature set through a feedback of the driver to the question and the set temperature is stored and the stored temperature is reset as a default value of each operation mode.

Later, when a user inputs an operation signal of the air conditioner, the air conditioner operates based on the reset temperature.

1. An automatic cooling/heating control method of an air conditioner for a vehicle, the control method comprising:
selecting an air operation mode desired by a user in the air conditioner;
starting an initial operation by the air conditioner after determining whether to cool, heat, or fan by measuring indoor temperature and outdoor temperature via the selected air operation mode;
setting the indoor temperature according to the outdoor temperature when the initial operation mode stops;
resetting the set indoor temperature by using a correction value according to present indoor temperature; and
operating by setting a reset indoor temperature to be a final set temperature by adding compensation temperature determined by each operation mode to the reset indoor temperature.

2. The control method of claim 1, further comprising:
determining a set value automatically and storing the set value in a micro controller unit (MCU) by manipulating the set temperature via upward and downward manipulations of a temperature manipulation button of the air conditioner and by reflecting a manipulated set temperature in temperature reset in each operation mode when an operation condition set as the final set temperature is not suitable for pleasantness of a user.

3. The control method of claim 1, wherein the air operation mode includes a pleasant mode, a cool mode, a temperate mode, a baby mode, and a speedy mode, wherein the pleasant mode, the cool mode, the temperate mode, the baby mode, and the speedy mode are set to be 24° C., 20° C., 27° C., 25° C., and 18° C., respectively.

4. The control method of claim 1, wherein the initial operation is maintained for two minutes.

5. The control method of claim 1, wherein the correction value according to the indoor temperature ranges between +2° C. and −2° C. when the indoor temperature is between 15° C. and 28° C., and
the compensation temperature is set to be 0° C. in a pleasant mode, −2° C. in a cool mode, +2° C. in a temperate mode, +3.5° C. in a baby mode, and −5° C. in a speedy mode,
wherein the temperature reset by adding the compensation temperature is set within a limitation value of the reset temperature according to the operation mode.

6. The control method of claim 5, wherein the limitation value of the reset temperature ranges to be 20° C. to 26° C. in the pleasant mode, 18° C. to 25° C. in the cool mode, 22° C. to 30° C. in the temperate mode, 20° C. to 28° C. in the baby mode, and 16° C. to 24° C. in the speedy mode.

7. The control method of claim 1, wherein the final set temperature is calculated every ten minutes.

8. The control method of claim 2, wherein the air operation mode includes a pleasant mode, a cool mode, a temperate mode, a baby mode, and a speedy mode, wherein the pleasant mode, the cool mode, the temperate mode, the baby mode, and the speedy mode are set to be 24° C., 20° C., 27° C., 25° C., and 18° C., respectively.

9. The control method of claim 2, wherein the initial operation is maintained for two minutes.

10. The control method of claim 2, wherein the correction value according to the indoor temperature ranges between +2° C. and −2° C. when the indoor temperature is between 15° C. and 28° C., and
the compensation temperature is set to be 0° C. in a pleasant mode, −2° C. in a cool mode, +2° C. in a temperate mode, +3.5° C. in a baby mode, and −5° C. in a speedy mode,
wherein the temperature reset by adding the compensation temperature is set within a limitation value of the reset temperature according to the operation mode.

11. The control method of claim 2, wherein the final set temperature is calculated every ten minutes.
